(19) United States
(12) Patent Application Publication
(10) Pub. No.: US 2010/0235986 A1
(43) Pub. Date: Sep. 23, 2010

(54) PORTABLE PATIENT TRANSFER SYSTEM

(76) Inventors: Alan Klyne, Mayne Island (CA); James Maden, South Delta (CA)

Correspondence Address: J. GORDON THOMSON, P.O. BOX 8865, VICTORIA, BC, V8V 3Z1, CA

(21) Appl. No.: 12/405,986

(22) Filed: Mar. 17, 2009

(51) Int. Cl. A61G 7/10

(52) U.S. Cl. 5/86.1; 5/81.1 R

(57) ABSTRACT

A system for moving a patient in a hospital or other care facility from a first flat surface to a second flat surface using a pulling apparatus and a modified reusable bed pad. The bed pad includes horizontal and vertical flexible reinforcing members sewn their entire length into the pad so as to form a grid of reinforcing members. At the end of each reinforcing member is a loop. The pulling apparatus comprises an electric motor and transmission developing adequate torque to pull the patient the required distance. The pulling apparatus uses two hook and strap combinations wound onto pulleys. The hooks engage the loops of the modified bed pad for pulling. A single operator may then move a patient from one surface to another.

### BACKGROUND

1. Field of the Invention

This invention relates to beds and in particular to invalid lift and transfer systems and specifically to a portable patient transfer system.

2. The Problem and the Prior Art

Moving an invalid patient from one surface to another surface is a common activity in care facilities. For example, patients can be moved from a bed to a gurney and then transported to an operating room where again they are moved from the gurney to an operating table. The amount of strength required to move an invalid or unconscious human body is often beyond the ability of a single person. Attempting to do so often results in serious and expensive musculoskeletal injuries to nursing staff and lost productivity to the care facility. The average age of a hospital nurse is 47 years. Statistics from the National Institute of Occupational Safety and Health and the Centre for Disease Control show that these workers have musculoskeletal injury rates greater than construction and manufacturing industries. Sprains and strains account for more than half of all hospital work-related injuries and the cost to the US health care industry is estimated to be in excess of 20 billion dollars annually. Proper lifting equipment and training has been shown to reduce the incidence of injury significantly. However, many types of devices currently available for patient lift are overly complex. This results in the equipment being abandoned by nursing staff and rendered useless in preventing injury. For example, U.S. patent application Ser. No. 11/151,064 “Patient Transfer Device” by Stryker et al. teaches a device that appears to be very complex to operate. The amount of pre-use activity in adjusting and setting-up the device appears to be both time-consuming and overly complicated. Such a device could fall out of favour amongst nursing staff. U.S. Pat. No. 7,114,203 “Lateral Transfer Accessory” by Lloyd et al. appears to be robust to the point of overbuilding. Hence this apparatus is likely expensive to purchase. It also requires the installation of attachment points to the bed sheet upon which the patient lies in order to pull the sheet with the patient on it to the second surface. U.S. Pat. No. 6,728,979 “Patient Transfer Device” issued to Robert requires the use of a back board upon which the patient is placed prior to movement. The physical effort required to place a patient on such a board would itself risk back injury.

Therefore, there is a need for a patient transfer device that is easy to use by a single individual that efficiently moves the patient and reduces the incidences of staff injury.

### SUMMARY OF THE INVENTION

The present invention is a portable patient transfer system that can be used at multiple bed locations throughout health care facilities by only one person. The invention can be used on either side of the bed as well as top and bottom to move a patient as required. The; invention is weighted to counter the thrust of pulling a patient as it abuts the bed while pulling. The balancing of weight between the top and bottom of the invention creates stability during the pull and so the invention does not move. The invention includes a modified reusable patient bed pad which is placed on a bed prior to placing a patient in the bed. Nylon transfer straps are sewn between the fabric layers of the bed pad. The modified bed pad has at least two nylon transfer strap loops projecting from its four sides. This will allow for the transfer hook of the pulling device to be placed through the nylon loop on the side of the pad and transfer the patient from any direction. The importance of this directionality is that the patient can be pulled up the bed or from each side of the bed no matter how the pad was originally placed on the bed or stretcher including what side was placed up or down. The use of the modified bed pads of the invention will reduce the number of attendants required and eliminate the need to use a special single use patient transfer medium such as a transfer board or transfer sheet under the patient to transfer them from one horizontal surface to another horizontal surface. Existing overhead patient lifts, portable patient lifts, transfer boards or hand pulled ergonomic transfer sheets that are now all in common use in the health care industry require the transfer medium to be first placed under the patient, and removed from under the patient when brought back to their bed. All of these existing methods of transfer require more than one attendant and require a single use transfer medium under the patient all of which also require more than one attendant to remove the transfer medium from under the patient after use. The system of the invention will create a complete health care operations system without any change to the facilities existing operations. The use of the invention will reduce back injuries, and reduce the number of staff required to transfer a patient. The use of modified bed pad stays with the patient throughout multiple patient transfers and so reduces the laundry load on the care facility.

There are multiple benefits to be accrued from using the invention:
It will alleviate back injuries suffered by nursing staff while transferring a patient from one bed to another;
It will alleviate back injuries suffered by nursing staff while sliding a patient up to the head of a bed;
It will benefit a patient being transferred from one stretcher to another by causing less of a jerking motion if being pulled by hand, resulting in less stress to the patient;
It will benefit a patient being moved from the bottom of a bed up to the head of the bed. Patients tend to slide down the bed and if unable to move themselves back up will need assistance to be moved back up the bed. Typically at least two nurses are needed to perform this task;
It will benefit the care facility that purchases invention because only one person is required to able to operate it and thereby transfer or slide a patient;
It is an improvement over an overhead lift device or portable lift device requires at least two nurses to place a lift sheet under the patient. Once the patient is on the lift sheet they can then be hoisted up in the air. This type of system is uncomfortable for the patient as the patient is hung in the air in what looks like a fishnet, and then moved in the air to another bed. Then the lift sheet is generally removed, again requiring two to three nurses depending on the size and weight of the patient;
It will benefit the patient who will not have to wait for the required numbers of staff to move the patient up or down the bed. The invention requires only one operator;
It will benefit the health care industry by reducing the incidences of musculoskeletal injuries and their heavy cost;
It will be affordable to even small institutions; and,
It has a small storage footprint;

Other benefits and advantages will become apparent from a consideration of the ensuing description and drawings.

### DESCRIPTION OF THE DRAWINGS

FIG. 1 is a front perspective view of one embodiment of the pulling apparatus of the invention.

FIG. 2 is a view of the invention being used to transfer a patient from one bed to another.

FIG. 3 A to D is a sequential diagram of the invention being used to transfer a patient.

FIG. 4 is a front perspective view of the internal components of one embodiment of the pulling apparatus of the invention.

FIG. 5 is a top view of the motor and pulley assembly of one embodiment of the pulling apparatus invention.

FIG. 6 is a top view of the modified patient bed pad of one embodiment of the invention.

FIGS. 7A and B is a top and side view of a hook and strap assembly of one embodiment of the invention.

### REFERENCES NUMBERALS IN THE DRAWINGS

10 pulling apparatus of the invention

12 patient

14 a first horizontal surface

16 a second horizontal surface

17 operator

18 base frame

19 moveable cage

20 casters

22 motor and pulley assembly

23 cushion

24 modified bed pad

26 grid of flexible reinforcing members

28 flexible reinforcing members

30 left vertical flexible reinforcing member

32 right vertical flexible reinforcing member

34 top horizontal flexible reinforcing member

36 bottom horizontal flexible reinforcing member

37 loop

38 hook and strap assembly

39 hook and strap assembly height

40 enclosed cabinet

42 electric motor

44 rotatable shaft

46 transmission means

48 transmission case

50 shaft centre point

52 first shaft end

54 second shaft end

55 first pulley

56 first spooling cover

58 second pulley

60 second spooling cover

62 input gear

64 electric motor drive axle

66 output gear

68 not used

70 battery

72 battery charger

74 not used

76 first hook and strap combination

78 second hook and strap combination

80 first hook

82 second hook

84 first strap

86 second strap

88 strap length

90 bias spring

92 pressure bar

94 stop switch

96 first aperture pressure bar

98 second aperture in pressure par

100 remote control

### DETAILED DESCRIPTION

Referring to the Figures, the invention combines a pulling apparatus 10 and a modified bed pad 24 to result in a portable patient transfer system for pulling a patient 12 from a first horizontal supporting surface 14 to an adjacent co-planar second horizontal supporting surface 16 and overcomes the deficiencies of the prior art. In one embodiment of the invention, the pulling apparatus and the modified bed pads are sold together as a kit. One pulling apparatus would be sold with a plurality of modified bed pads to a single care facility. In another embodiment, the pulling apparatus can be sold separately from the modified bed pad. However, in all embodiments of the invention, the pulling apparatus 10 is intended to work with the modified bed sheet 24 to form the portable patient transfer system for pulling a patient.

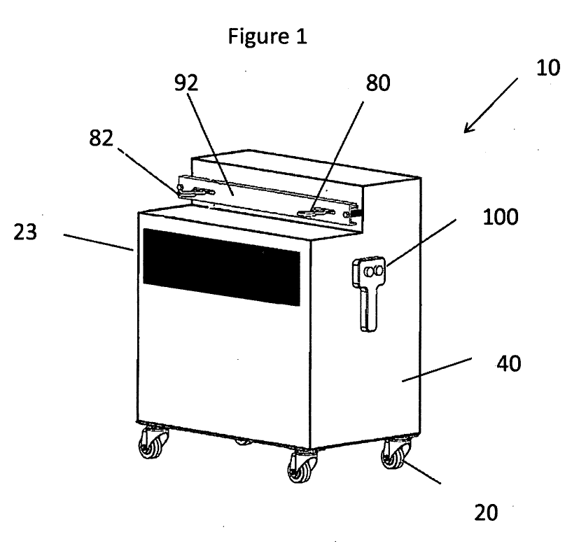

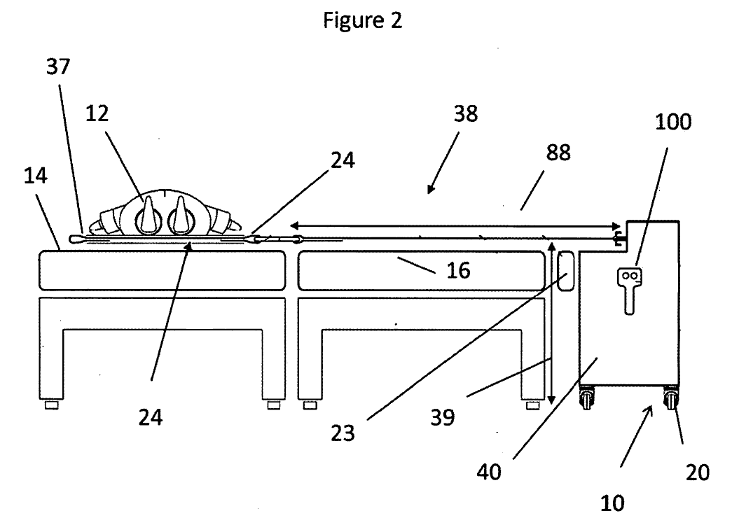

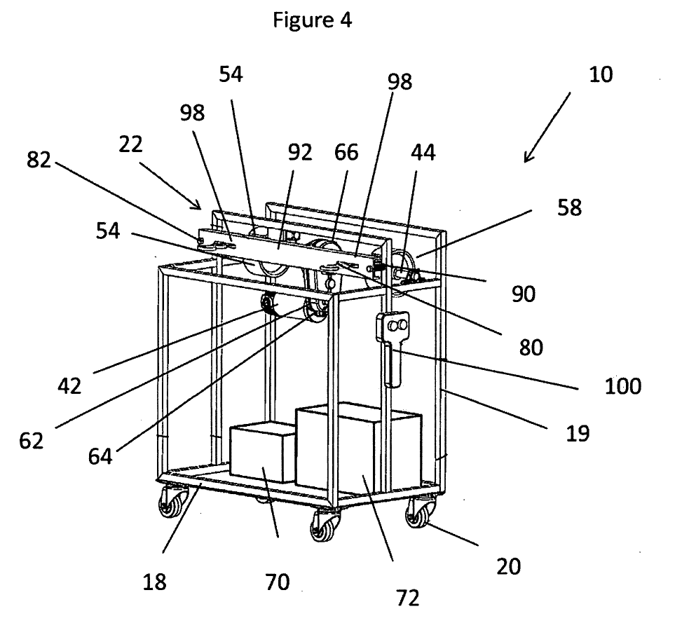

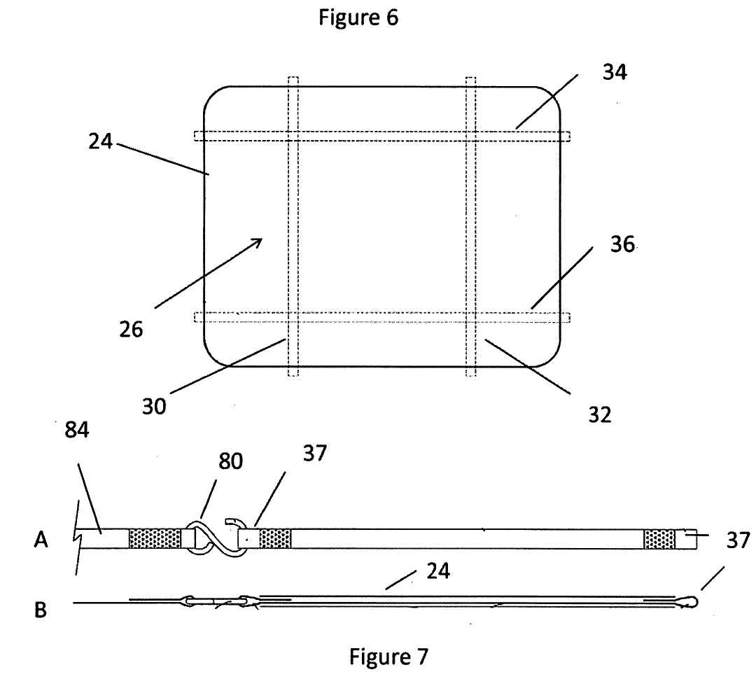

The system is adapted for use by a single individual 17 and so saves time, effort and labour costs. The pulling apparatus 10 of the system illustrated in FIGS. 1 and 4 comprises a moveable base frame 18 for positioning the pulling apparatus adjacent to the second horizontal supporting surface 16 shown in FIG. 2. The base frame is mounted on casters 20 so that it can be easily moved around by a single individual. A motor and pulley assembly 22 is mounted to a moveable cage 19 as shown in FIG. 4 for providing the pulling force required to move the patient 12 from the first surface 14 to the second surface 16 as shown in FIG. 2. In FIG. 2, the patient 12 is disposed upon a reusable bed pad 24. The pad is illustrated in FIG. 6. These types of bed pads are commonly found in hospitals and other care facilities to protect the bed and patient from fluids. However, in the system of the invention the reusable bed pad 24 is modified to work exclusively with the pulling apparatus 10. The modified bed pad 24 comprises a grid 26 of a plurality of reinforcing flexible members 28 sewn along their entire length within the bed pad. Typically there are two vertical reinforcing members 30 and 32 and two horizontal reinforcing members 34 and 36 sewn within each bed pad. There could be three horizontal and vertical members used depending on the size of the pad. At each end of each member there is a loop 37 as shown in FIG. 7 formed by bending excess member material back on itself and sewing the resulting overlap together. The use of the modified bed pad of the invention negates the need to use pulling sheets and pulling boards and disturb the patient by placing the pulling sheet/board under the patient. Furthermore, the inclusion of the reinforcing straps and loops in each of the bed pads negates the use of any clamping rods or attachment points on the bed sheets or pulling sheets which complicates the pulling process. Hence the system of the invention is simple, easy to use and does not disturb the patient. A hook and strap assembly 38 in FIG. 2 is used to connecting the motor and pulley assembly 22 to the connecting loops 37 of the modified bed pad 24.

In one embodiment of the invention, as shown in FIG. 1, there is an enclosed cabinet 40 mounted to the base frame 18 for housing the motor and pulley assembly 22 and for supporting the hook and strap assembly 38 so that it is at the same height 39, as shown in FIG. 2, and co-planar with the second horizontal surface 16. Since all hospital beds have adjustable heights it is not necessary to include height adjustment on this invention. This significantly reduces the cost of manufacture and sale of system and reduces complexity for the user. Between the pulling apparatus 10 and the second horizontal surface 16 there is a cushion 23 to avoid damage to the apparatus.

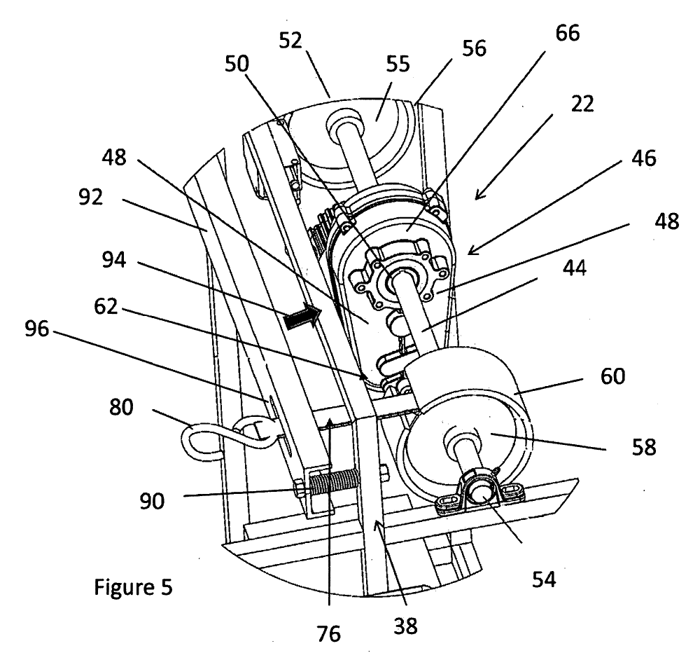

In FIG. 4 and FIG. 5, the motor and pulley assembly 22 comprise an electric motor 42 disposed beneath a rotatable shaft 44 mounted to the top portion of the cage 19. The shaft is connected to the motor by transmission means 46 housed in a transmission case 48. The shaft has mid-point 50, a first end 52 and a second end 54. The rotatable shaft 44 comprises a first driven pulley 55 with a first spooling cover 56 fixed to the rotating shaft first end 52 and a second driven pulley 58 with a second spooling cover 60 fixed to the rotating shaft second end 54. The rotation of the shaft unspools the strap off of the pulley. The spooling covers permit the straps to be unspooled without entanglement on the pulley and then pulled out from under the spooling covers for connection to the bed pad.

The transmission means 46 comprises an input gear 62 within the case 48 mounted to the electric motor 42 drive axle 64 and an output gear 66 within the case 48 mounted to the mid-point 50 of the rotating shaft 44. The gear ratio provides sufficient torque to provide at least 400 lbs of pulling force across a horizontal surface in each of the hook and strap assemblies 38.

The input gear and the output gear are connected by a gear drive not illustrated and housed within the transmission case 48. In a preferred embodiment of the invention the electric motor is DC powered. Hence, the cage 19 mounts a 12V DC battery 70 connected to the motor 42 and a battery charger 72 connected to the 12V battery. In another embodiment of the invention, the electric motor is AC powered.

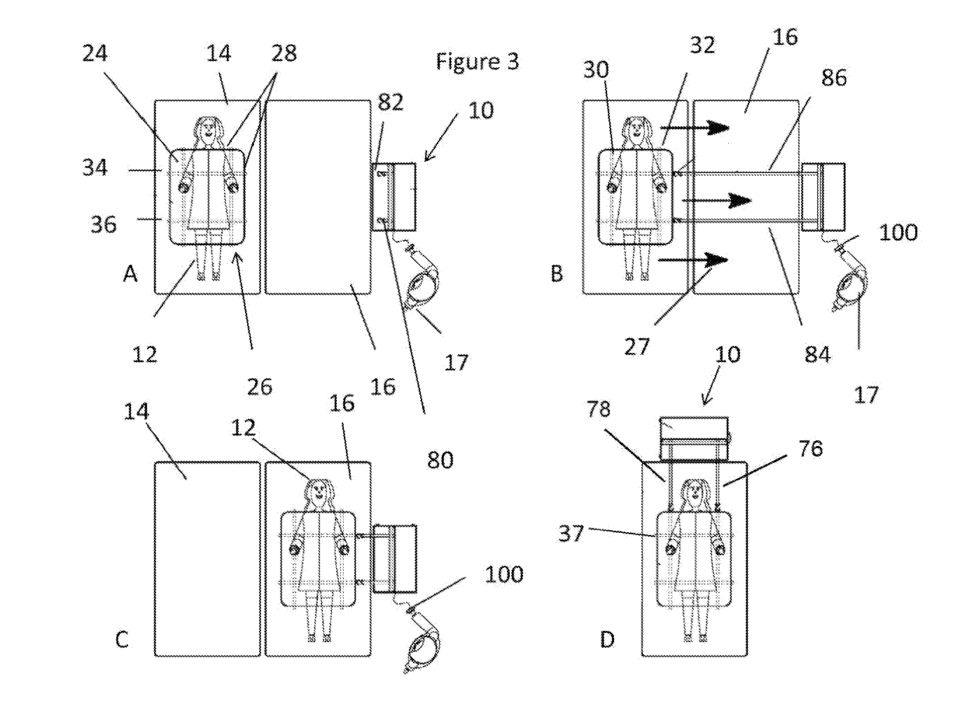

In FIG. 5, the hook and strap assembly 38 comprises a first strap and hook combination 76 connected to the first driven pulley 55 and a second hook and strap combination 78 connected to said second driven pulley 58. In FIG. 4, the hooks 80 and 82 are plastic coated “S” hooks having a tensile load rating of at least 400 lbs. The straps 84 and 86 in FIG. 3 have a tensile load rating of at least 400 lbs. In FIG. 2, the first and second straps each have a length 88 equal to at least 0.75 times the combined width of said first and said second horizontal supporting surfaces. The first 84 and second straps 86 are wound onto the respective first 55 and second 58 driven pulleys for storage.

In FIG. 5, the hook and strap assembly 38 further comprises a spring 90 biased pressure bar 92 having a contact switch 94 electrically connected to the motor 42, and a first 96 and second 98 aperture through which the first 84 and second straps 86 are drawn. As the first and second hook and strap assemblies are rewound onto their respective pulleys, the respective first and second hooks contact the pressure bar and activate said contact switch thereby cutting electricity to the motor.

The system further includes a remote controller 100 for motor operation. The motor may be able to operate in a forward and reverse rotation mode and so pay out the hook and strap assemblies. In this embodiment the remote controller will have controls to actuate reverse and forward rotation of the motor.

Referring to FIG. 3, the invention also teaches a single person operable method of using the pulling apparatus 10 and modified bed pad 24 to move a patient 12 from a first horizontal 14 surface to a second co-planar and adjacent horizontal surface 16. In FIG. 3A, the patient 12 is initially disposed on a reusable bed pad 24 having a grid 28 of reinforcing flexible members sewn along their entire length and a loop 37 formed at the distal ends of each of the reinforcing flexible members. The steps comprise:
a. In FIG. 3A, positioning the pulling apparatus 10 adjacent to the second horizontal surface 16. The pulling apparatus used in FIG. 3A is the same as the pulling apparatus described in FIG. 4 and FIG. 5 and includes a frame 19 mounted on swivel casters 20; an electric motor 42 and a rotatable shaft 44 mounted to the frame 19. The electric motor is disposed below the rotatable shaft and drives the rotatable shaft through a transmission 46, and the rotatable shaft is at the same height 39 as said second horizontal surface 16 (FIG. 2) and includes a pulley and clutch assembly fixed to each end of the shaft. The hook and strap assembly 38 is wound on each of the pulleys for connecting the hooks 80 and 82 to the loops on the modified bed pad 37 adjacent to the pulling apparatus;
b. In FIG. 3B, the straps 84 and 86 are deployed from the pulleys and the hooks are connected to the loops on the modified bed pad. The operator 17 activates the motor by hand-held remote operator 100 and pulls the patients towards the second horizontal surface 16 as shown by arrows 27;
c. In FIG. 3C, once the patient 12 is on the second surface 16 the operator ceases motor operation and disconnects the hooks from the loops;
a. In FIG. 3D, the pulling unit 10 can be positioned at the head of the bed so pull the patient up the bed.

Although the description above contains many specificities, these should not be construed as limiting the scope of the invention but as merely providing illustrations of some of the presently preferred embodiments of this invention. For example, the torque of the motor can be increased or decreased and the strength of the reinforcing members and hooks can be changed. In another embodiment the pulling assembly may be permanently installed at the head of the bed on top of the head board. The scope of this invention should be determined by the appended claims and their legal equivalents rather than by the examples given.

1. A portable patient transfer system for pulling a patient from a first horizontal supporting surface to an adjacent co-planar second horizontal supporting surface, said transfer system comprising, in combination, a moveable pulling apparatus for pulling said patient from said first to said second surface and a modified reusable bed pad upon which the patient is disposed and upon which the patient is pulled, wherein said pulling apparatus connects to said reusable bed pad by a hook and strap assembly and is operable by a single person, and wherein said reusable bed pad comprises a grid of a plurality of reinforcing flexible members sewn along their entire length inside the reusable bed pad and a loop formed at the distal ends of each of said plurality of reinforcing flexible members for connection with said hook and strap assembly.

2. The system of claim 1, wherein the moveable pulling apparatus comprises a moveable cage comprising a base frame to which are corner mounted swivel castors permitting easy movement of the pulling apparatus in all horizontal directions for positioning adjacent to said second horizontal supporting surface and a motor and pulley assembly mounted to said moveable cage for providing a pulling force to move the patient from the first surface to the second surface.

3. (canceled)

4. (canceled)

5. The system as claimed in claim 2, wherein the pulling apparatus further comprises an enclosed cabinet mounted around said cage for housing the motor and pulley assembly and for supporting the hook and strap assembly co-planar with the second horizontal surface.

6. (canceled)

7. (canceled)

8. (canceled)

9. (canceled)

10. (canceled)

11. (canceled)

12. (canceled)

13. The system as claimed in claim 5, wherein said grid of plurality of reinforcing flexible members comprises at least two horizontal members and at least two vertical members, wherein the at least two horizontal members are disposed within the reusable bed pad and sewn into the reusable bed pad along their entire lengths, and wherein each end of the at least two vertical members and the at least two horizontal members terminate in a loop for attachment to a hook of said hook and strap assembly.

14. (canceled)

15. (canceled)

16. (canceled)

17. (canceled)

18. (canceled)

19. A portable patient transfer system for pulling a patient from a first horizontal supporting surface to an adjacent co-planar second horizontal supporting surface, said transfer system comprising:
a. A cage mounted on swivel casters for positioning adjacent to said second horizontal supporting surface;
b. An electric motor and a rotatable shaft mounted to said cage, wherein said electric motor is disposed below said rotatable shaft and drives the rotatable shaft through a transmission, and wherein the rotatable shaft is at the same height as said second horizontal surface and includes a pulley assembly fixed to each end thereof, so that said electric motor engages said pulley assembly for clockwise rotation and winding a hook and strap assembly onto each of them, and counter-clockwise rotation of the pulley assembly for unwinding the hook and strap assembly; and,
c. A reusable bed pad upon which said patient is disposed, wherein said reusable bed pad comprises a grid of a plurality of reinforcing flexible members sewn along their entire length therein and a loop formed at the distal ends of each of said plurality of reinforcing flexible members so that each hook of said hook and strap assembly is attached to said proximate loop of adjacent ends of the reinforcing flexible members.

20. A method of moving a patient from a first horizontal surface to a second co-planar and adjacent horizontal surface, wherein said patient is disposed on a reusable bed pad having a grid of reinforcing flexible members sewn along their entire length therein and a loop formed at the distal ends of each of said plurality of reinforcing flexible members, said method comprising the steps of:
a. Positioning a portable patient transfer system adjacent to said second horizontal surface, said system comprising:
i. A cage mounted on swivel casters;
ii. An electric motor and a rotatable shaft mounted to said cage, wherein said electric motor is disposed below said rotatable shaft and drives the rotatable shaft through a transmission, and the rotatable shaft is at the same height as said second horizontal surface and includes a pulley assembly fixed to each end thereof; and,
iii. A hook and strap assembly wound on each of said pulleys for connecting said hook to said loop;
b. Pulling the hook and strap assembly from each of the pulleys;
c. Attaching the hooks to the loops along the adjacent parallel side of said reusable bed pad; and,
d. Engaging said electric motor thereby winding the straps onto the pulleys and pulling the patient onto the second horizontal surface.
